(19) United States
(12) Patent Application Publication
(10) Pub. No.: US 2021/0329924 A1
(43) Pub. Date: Oct. 28, 2021

(54) METAL-BASED ANTIMICROBIAL COMPOSITION AND METHOD OF USING

(71) Applicant: Microbonds Inc., Markham (CA)

(72) Inventors: Robert LYN, Markham (CA); John PERSIC, Toronto (CA)

(21) Appl. No.: 16/910,457

(22) Filed: Jun. 24, 2020

Related U.S. Application Data
(60) Provisional application No. 63/016,803, filed on Apr. 28, 2020.

(51) Int. Cl. A01N 59/20; A01N 25/02

(52) U.S. Cl. CPC A01N 59/20; A01N 25/02

(57) ABSTRACT

In one aspect, there is provided an antimicrobial compound having the formula [Meₓ(NH3)_{y}]—Z, where Me is a metal selected from the group consisting of copper, silver and zinc, and Z is selected from the group consisting of, a salt of an organic acid having at least one (—COOH) functional group, or a salt of an inorganic acid.

### CROSS-REFERENCE TO RELATED APPLICATION

This application claims the benefit of U.S. Provisional application No. 63/016,803 filed Apr. 28, 2020, the contents of which is incorporated herein by reference in its entirety.

### FIELD OF THE DISCLOSURE

The specification relates generally to antimicrobial compositions, and, in particular, antimicrobial compositions that can be used to treat different substrates without adversely affecting those substrates.

### BACKGROUND OF THE DISCLOSURE

Antimicrobial technology describes the collective knowledge, expertise and methods of using materials to create products that are protected against microbes.

Silver, copper and zinc have been used for their antimicrobial properties for centuries. Now, manufacturers are incorporating these metals into healthcare, food industry and even some consumer products. In particular, there are many companies introducing a range of new products from work tops to door handles, which are then marketed as antimicrobial; some such products claim to be effective against MRSA, a potentially deadly hospital-acquired infection.

Current state-of-the-art antimicrobial compositions include the following groups: quaternary ammonium compound (QACs), Triclosan, Elemental Copper, Elemental Zinc, Zinc Ion, Elemental Silver, Silver nanoparticles, Silver Ion, Silver Zeolite and Formaldehyde donors.

The antimicrobial range of QACs is less than that of the oxidizing disinfectants. They are less effective against Gram-negative bacteria than against Gram-positive bacteria. They also have limited activity against bacterial spores and very little activity against viruses. To be effective against yeasts and molds, higher concentrations are required. Furthermore, because of their long-term and widespread use, bacteria have developed resistance to QACs.

Elemental copper and elemental silver have proven historically to be excellent antimicrobial agents, being used in touch surfaces such as brass doorknobs and sterling silver vessels and flatware; however, creating a solid metallic copper or silver surface onto a wide range of surfaces requires an expensive and complicated chemical plating process or a vacuum plasma deposition process with reliable adhesion being a concern. Regardless, an inherent advantage of silver and copper based antimicrobial technologies is the difficulty for bacteria, viruses, mold and fungi to evolve and develop antimicrobial resistance. Antimicrobial resistance is becoming a progressively greater problem, and is particularly acute in the field of antibiotics.

Silver Zeolites are antimicrobial technology that is enabled by loading a ceramic mineral, called a zeolite, with silver salts to effect a controlled release of silver ions; however, by its nature, the adhesion of ceramic materials to most substrates is poor and can also change the look or feel of the substrate, especially for substrates that are fabrics or other soft materials.

Triclosan is a chemical that has been widely used as an antimicrobial agent; however, increasing studies have shown that it can cause negative health issues and thus has become banned in some countries.

Formaldehyde donors, another chemical antimicrobial agent, present a similar health hazard as Triclosan, i.e., having the risk of breaking down to formaldehyde which is a known carcinogen.

Silver nanoparticle antimicrobials, including colloidal silver, have been proven effective across a broad spectrum; however, they suffer from problems of adhesion and washing out of treated articles; therefore, silver nanoparticles are mixed into polymer carriers which bind and adhere to the surfaces, but also reduce the efficacy of the silver itself. Furthermore, there is some concern about the health and safety of nanoparticles in general, due to the fact that their size is on the same order of human cells. For colloidal silver, the metallic silver concentrations that have been approved as safe by regulatory agencies are in the range of less than 10 ppm, which have not proven to be consistently effective in providing desired health benefits and have become controversial.

Silver ion antimicrobial technology is promising, but suffers from similar adhesion issues as silver nanoparticles, necessitating the need for polymers or co-polymers to be added to act as an adhesive to bind them to the target surface, reducing efficacy. These polymers are typically subjected to elevated temperatures, such as temperatures greater than 120 C, to allow the polymers to flow and ‘cure’ onto the target surface, which adds significant cost and complexity to using silver ion technology. Additionally, silver ion technologies have the inherent problem of silver staining at high silver content, which is characterized by an unsightly brown-coloured stain when the silver ions oxidize to silver oxide. Because antimicrobial efficacy is directly proportional to higher silver content, a high efficacy silver ion antimicrobial agent cannot be easily achieved on a white or light coloured surface without silver staining. Copper exhibits a similar staining problem as silver, in the transition to a dark red/brown copper oxide which is highly inert and does not adhere to any surface without polymers of binder additives. Zinc antimicrobials are typically less-staining white coloured compounds found as zinc oxide, or zinc salts; however, they are highly non-reactive and require polymers for adhesion.

### SUMMARY OF THE DISCLOSURE

In one aspect, there is provided an antimicrobial compound having the formula [Meₓ(NH3)_{y}]—Z, where Me is a metal selected from the group consisting of copper, silver and zinc, and Z is selected from the group consisting of, a salt of an organic acid having at least one (—COOH) functional group, or a salt of an inorganic acid.

In another aspect, a method is provided for treating a substrate, comprising:

a) providing a substrate;

b) providing an antimicrobial composition that includes an antimicrobial compound having the formula [Meₓ(NH3)_{y}]—Z, where Me is a metal selected from the group consisting of copper, silver and zinc, and Z is selected from the group consisting of, a salt of an organic acid having at least one (—COOH) functional group, or a salt of an inorganic acid, in an aqueous or organic solvent;

c) disposing the antimicrobial composition onto the substrate; and

d) evaporating the solvent fully from the substrate at a temperature of between 10 and 120 degrees Celsius, and leaving one of: the metal in elemental form, an oxide of the metal, or a compound with the formula Me(NH)a-Z.

In yet another aspect, a method is provided for making the antimicrobial composition described above and elsewhere herein, comprising:

a) reacting a metal salt with a chemical containing an N—H chemical group, such as an organo-amine, alkylamine, amino acid, ammonium hydroxide or ammonia gas to form a precursor complex; and

b) reacting the precursor complex with an organic acid having at least one (—COOH) functional group or with an inorganic acid selected from the group consisting of: Sulfurous Acid, Sulfuric Acid, Hyposulfurous Acid, Persulfuric Acid, Pyrosulfuric Acid, Disulfurous Acid, Dithionous Acid, Tetrathionic Acid, Thiosulfurous Acid, Hydrosulfuric Acid, Peroxydisulfuric Acid, Perchloric Acid, Hydrochloric Acid, Hypochlorous Acid, Chlorous Acid, Chloric Acid, Hyponitrous Acid, Nitrous Acid, Nitric Acid, Pernitric Acid, Carbonous Acid, Carbonic Acid, Hypocarbonous Acid, Percarbonic Acid, Phosphoric Acid, Phosphorous Acid, Hypophosphous Acid, Perphosphoric Acid, Hypophosphoric Acid, Pyrophosphoric Acid, Hydrophosphoric Acid, Hydrobromic Acid, Bromous Acid, Bromic Acid, Hypobromous Acid, Hypoiodous Acid, lodous Acid, Iodic Acid, Periodic Acid, Hydroiodic Acid, Fluorous Acid, Fluoric Acid, Hypofluorous Acid, Pertluoric Acid, Hydrofluoric Acid, Chromic Acid, Chromous Acid, Hypochromous Acid, Perchromic Acid, Hydroselenic Acid, Selenic Acid, Selenous Acid, Hydronitric Acid, Boric Acid, Molybdic Acid, Perxenic Acid, Silicofluoric Acid, Telluric Acid, Tellurous Acid, Tungstic Acid, Xenic Acid, Pyroantimonic Acid, Permanganic Acid, Manganic Acid, Antimonic Acid, Antimonous Acid, Silicic Acid, Titanic Acid, Arsenic Acid, Pertechnetic Acid, Hydroarsenic Acid, Dichromic Acid, Tetraboric Acid, Metastannic Acid, Hypooxalous Acid, Ferricyanic Acid, Cyanic Acid, Silicous Acid, Hydrocyanic Acid, Thiocyanic Acid, Uranic Acid, and Diuranic Acid.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 is a flow diagram illustrating a method of making an antimicrobial composition, in accordance with an embodiment of the present disclosure.

FIG. 2 is a flow diagram illustrating a method of treating substrate, in accordance with an embodiment of the present disclosure.

FIG. 3 is a plan view of a substrate prior to treating with an antimicrobial composition.

FIG. 4A is a plan view of the substrate shown in FIG. 3 after treating with an antimicrobial composition having a first, final usage concentration.

FIG. 4B is a plan view of the substrate shown in FIG. 3 after treating with an antimicrobial composition having a second, final usage concentration.

FIG. 5 is a graph of the Delta E value for a selected substrate.

FIG. 6 is a graph showing concentration values for Silver in the antimicrobial composition, and their impact on greyscale shift.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, chemical, thermal and other changes may be made without departing from the scope of the present invention. The following detailed description is, therefore, not to be taken in a limiting sense, and the scope of the present invention is defined only by the appended claims.

In the present disclosure, specific details are set forth to provide a thorough understanding of certain embodiments. However, it is understood that the invention may be practiced without these specific details. In other instances, well-known structures and techniques known to one of ordinary skill in the art have not been shown in detail in order not to obscure the invention.

The present disclosure relates, in a first aspect, to an antimicrobial composition that includes a compound having the formula [Meₓ(NH3)_{y}]—Z, where Me is copper or silver or zinc, and where Z is the salt of a strong organic acid having at least one (—COOH) functional group or is the salt of an inorganic acid. The antimicrobial composition has been found to have a number of advantageous properties. For example, the antimicrobial composition has been found to have a high kill rate against standard reference microbes. Additionally, in at least some embodiments, the antimicrobial composition has been found to chemically bond directly to a substrate without the use of polymers or binding agent additives. In at least some embodiments, the antimicrobial composition has been found to bond to surfaces at low temperatures (temperatures that are less than or equal to 100 degrees Celsius, and in some embodiments, temperatures that are approximately 20 degrees Celsius). In at least some embodiments, the antimicrobial composition is selected to be applied to a substrate such that any change in colour of the substrate resulting from application of the antimicrobial composition thereon, is less than a selected value. In at least some embodiments, the antimicrobial composition can bond (e.g. chemically bond) to one or more of a wide range of organic surfaces including: textiles, polymers, plants, animals and human tissue, without the aid of polymer, adhesives, binders, or other non-room temperature evaporating or residue leaving agents to assist or promote adhesion.

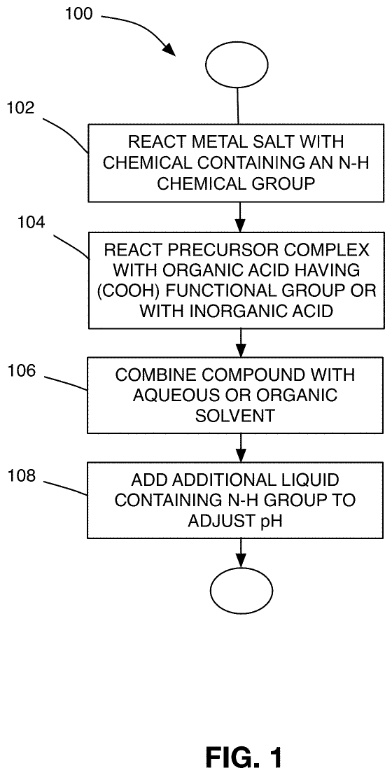

The antimicrobial composition is fabricated by various methods, such as a method shown at 100 in FIG. 1, which includes: a first step 102 of reacting a metal salt with a chemical containing an N—H chemical group, such as an organo-amine, alkyamine, amino acid, ammonium hydroxide or ammonia gas to form a precursor complex, and then a second step 104 of reacting the precursor complex with an organic acid having at least one (—COOH) functional group OR reacting the precursor complex with an inorganic acid. Examples of an inorganic acid include: Sulfurous Acid, Sulfuric Acid, Hyposulfurous Acid, Persulfuric Acid, Pyrosulfuric Acid, Disulfurous Acid, Dithionous Acid, Tetrathionic Acid, Thiosulfurous Acid, Hydrosulfuric Acid, Peroxydisulfuric Acid, Perchloric Acid, Hydrochloric Acid, Hypochlorous Acid, Chlorous Acid, Chloric Acid, Hyponitrous Acid, Nitrous Acid, Nitric Acid, Pernitric Acid, Carbonous Acid, Carbonic Acid, Hypocarbonous Acid, Percarbonic Acid, Phosphoric Acid, Phosphorous Acid, Hypophosphous Acid, Perphosphoric Acid, Hypophosphoric Acid, Pyrophosphoric Acid, Hydrophosphoric Acid, Hydrobromic Acid, Bromous Acid, Bromic Acid, Hypobromous Acid, Hypoiodous Acid, lodous Acid, Iodic Acid, Periodic Acid, Hydroiodic Acid, Fluorous Acid, Fluoric Acid, Hypofluorous Acid, Perfluoric Acid, Hydrofluoric Acid, Chromic Acid, Chromous Acid, Hypochromous Acid, Perchromic Acid, Hydroselenic Acid, Selenic Acid, Selenous Acid, Hydronitric Acid, Boric Acid, Molybdic Acid, Perxenic Acid, Silicofluoric Acid, Telluric Acid, Tellurous Acid, Tungstic Acid, Xenic Acid, Pyroantimonic Acid, Permanganic Acid, Manganic Acid, Antimonic Acid, Antimonous Acid, Silicic Acid, Titanic Acid, Arsenic Acid, Pertechnetic Acid, Hydroarsenic Acid, Dichromic Acid, Tetraboric Acid, Metastannic Acid, Hypooxalous Acid, Ferricyanic Acid, Cyanic Acid, Silicous Acid, Hydrocyanic Acid, Thiocyanic Acid, Uranic Acid, and Diuranic Acid.

In a third step 106, the resultant compound from the second step has the formula Meₓ(NH3)_{y}]—Z, as described above. The resultant compound is then further combined with a low temperature evaporating aqueous or organic solvent such as: n-Pentane, n-Hexane, n-Heptane, n-Octane, n-Nonane, n-Decane, 2,2,4-Trimethylpentane, Cyclohexane, Benzene, Toluene, Ethylbenzene, Xylene, Tetralin, Methanol, Ethanol, n-Propanol, i-Propanol, n-Butanol, i-Butanol, s-Butanol, n-Amyl alcohol, i-Amyl alcohol, Cyclohexanol, n-Octanol, Ethanediol, Diethylene 1,2-Propanediol glycol, Propylene glycol methyl ether, Ethylene glycol methyl ether, Ethylene glycol ethyl ether, Ethylene glycol monobutyl ether, Methylene chloride, Chloroform, Carbon tetrachloride, 1,2-Dichloroethane, Trichloroethylene, Perchloroethylene, Monochlorobenzene, Acetone, Methyl ethyl ketone, Methyl isobutyl ketone, Cyclohexanone, n-Methyl-2-pyrrolidone, Acetophenone, Diethyl ether, Diisopropyl ether, Dibutyl ether, Methyl tert butyl ether, 1,4-Dioxane, Tetrahydrofuran, Methyl acetate, Ethyl acetate, Isopropyl acetate, n-Butyl acetate, Cellosolve acetate, Dimethylformamide, Dimethylacetamide, Dimethylsulphoxide, Sulfolane, Carbon duisulphide, Acetic acid, Aniline, Nitrobenzene, Morpholine, Pyridine, 2-Nitropropane, Acetonitrile, Furfuraldehyde, Phenol or water. The aqueous or organic solvent is used to dilute the metal loading content of the final antimicrobial composition to a selected level, following a procedure as described below. At step 108, an additional liquid is added to the solvent. The additional liquid contains an N—H chemical group and is provided so as to adjust the pH of the composition to be greater than 8. This helps to stabilize the composition, (i.e. to keep the antimicrobial compound in solution). Examples of suitable products to add to the solvent include, for example, ammonium hydroxide or a primary organo-amine or alkyl-amine.

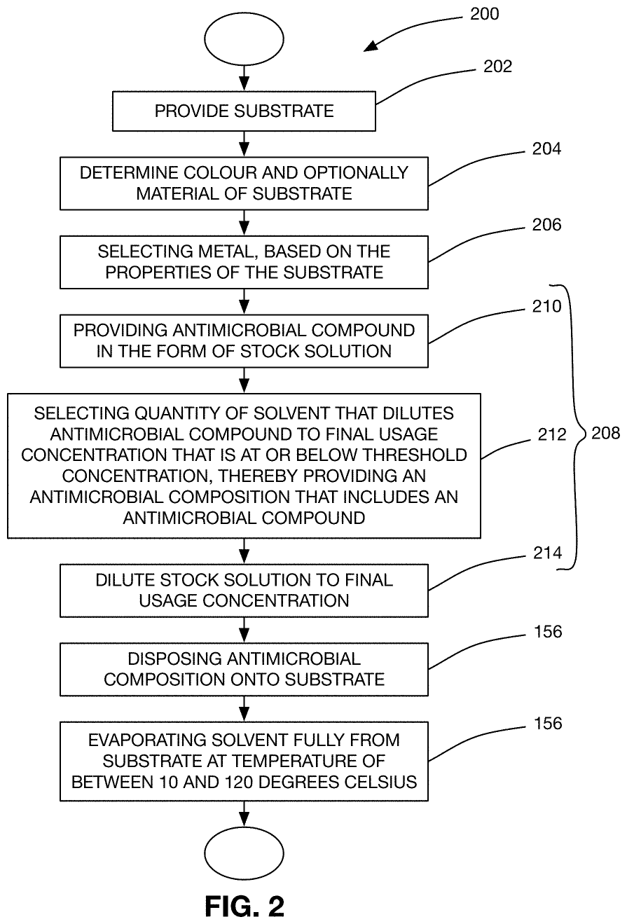

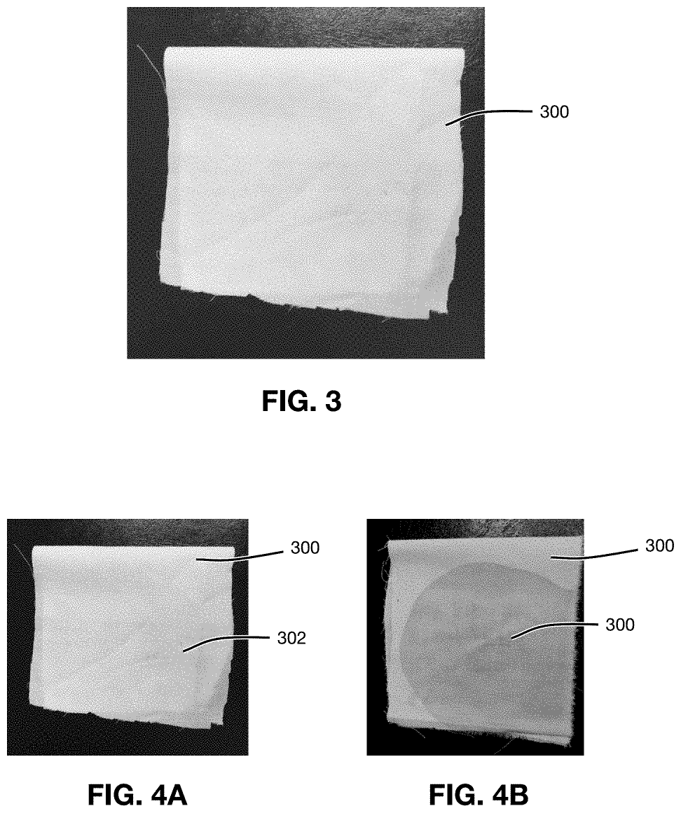

In an embodiment, a method for treating a substrate in accordance with the present disclosure is shown at 200 in FIG. 2. The method includes a step 202 in which a substrate is provided. An example of a substrate is shown at 300 in FIG. 3. The substrate 300 may be any suitable material, such as, but not limited to: porous surfaces such as textiles, polymers, plants, and other organic substrates including human and animal skin and hair. The substrate may be an organic material, a ceramic material, a polymer, a metal or any other suitable type of material. In the example shown in FIGS. 3, 4A and 4B, the substrate 300 is cotton fabric.

A step 204 entails determining the colour of the substrate. Optionally, the material of the substrate is also determined at step 204. At step 206, a metal that is to be part of an antimicrobial composition is selected, based at least in part on the colour of the substrate (and optionally on the material of the substrate). At step 208, the antimicrobial composition is provided. The antimicrobial composition includes an antimicrobial compound having the formula [Meₓ(NH3)_{y}]—Z, as described elsewhere herein, and further includes an aqueous or organic solvent.

Optionally, step 208 includes a step 210, a step 212 and a step 214. At step 210, the antimicrobial compound is provided in the form of a stock solution having a first concentration, such as, for example, 100000 ppm. Step 212 entails selecting a quantity of the solvent that dilutes the antimicrobial compound to a final usage concentration that is at or below a threshold concentration, so as to limit any change in colour of the substrate to have a Delta E value that is than a threshold Delta E value. Step 214 entails diluting the stock solution to the final usage concentration using the quantity of the solvent.

A Delta E value is a value that relates to changes in the colour of an item. It has been found that a Delta E value of less than or equal to 1 is considered to be not perceptible by the human eye. A Delta E value of between 1 and 2 is considered to be perceptible through close observation. A Delta E value of between 2 and 10 is considered to be perceptible at a glance. Delta E values above 10 are clearly perceptible.

The formula for determining Delta E has evolved over the years towards greater accuracy in terms of representing the true change in colour of a substrate. The formula used for the purposes of the present disclosure may be the following formula established by the International Commission on Illumination (CIE):

Delta E=√((ΔL′/K_{L}S_{L})²+(ΔC′/K_{C}S_{C})²+(ΔH′/K_{H}S_{H})²+R_{T}(ΔC′/K_{C}S_{C})(ΔH′/K_{H}S_{H}))

A discussion of this formula may be found in the publication entitled “The CIEDE2000 Color-Difference Formula: Implementation Notes, Supplementary Test Data, and Mathematical Observations” by Gaurav Sharma, Wencheng Wu, and Edul N. Dalai. The contents of this publication are incorporated herein by reference.

The threshold Delta E value may be selected to be 2 in order that the change in colour of the substrate is difficult to perceive unless under close observation. In some embodiments, however, the threshold Delta E value may be selected to be greater than 2 and less than 10, for substrates that do not need to be, for example, a very bright white, or for other applications where a limited amount of discoloration is tolerable.

FIG. 4A shows the substrate 300 when treated with the antimicrobial composition having a final usage concentration of 100 ppm (and wherein the metal selected is Silver). As can be seen, there is some, but relatively little discoloration of the substrate 300, seen upon careful inspection of the region 302. FIG. 4B shows the substrate 300 when treated with the antimicrobial composition having a final usage concentration of 3000 ppm (and wherein the metal selected is Silver). As can be seen, there is significant discoloration of the substrate 300 in the region 304.

Referring again to FIG. 2, at step 216, an additional liquid is added to the solvent, the additional liquid containing an N—H chemical group, in similar manner to step 108 of FIG. 1, so as to adjust the pH of the composition to be greater than 8, which in turn helps to stabilize the composition.

At step 218, the antimicrobial composition is disposed onto the substrate 300. The application of the antimicrobial composition on the substrate 300 may be by any suitable means and will depend on the particular substrate and the particular antimicrobial composition involved. For example, if the composition is a solution, and the substrate is a sheet of fabric, the antimicrobial composition may be applied onto the target substrate as fine droplets, such as in an aerosol spray or mist, generated by a misting apparatus. In some embodiments, the substrate may be immersed in the solution. In some other embodiments, the antimicrobial composition is first applied onto a flexible applicator, such as tissue paper, fabric or sponge material and then wiped onto the substrate 300. In some embodiments a priming coating composition is applied to the substrate 300 to prime the surface of the substrate 300 for accepting the composition, prior to applying the composition. This priming coating composition is not considered part of the antimicrobial composition.

At step 220, the solvent is evaporated fully from the substrate 300 at a temperature of between 10 and 120 degrees Celsius, and leaving an antimicrobial material on the material, which is one of: the metal in elemental form, an oxide of the metal, or a compound with the formula Me(NH)a-Z on the substrate 300. Examples of this are shown in FIGS. 4A and 4B. It will be noted that the use of N—H group-containing products to adjust the pH are advantageous because they evaporate at a low-enough temperature that they would evaporate along with the solvent at relatively low temperature, to leave only the aforementioned metal in elemental form, metal oxide, or the noted metal compound, on the substrate 300. For greater certainty, it will be understood that in some instances the elemental metal will be left and over time it will form the metal oxide either completely or partially.

In some embodiments, depending on the solvent chosen, the solvent may be evaporated fully from the substrate at a temperature of between 20 and 100 degrees Celsius. For example, in some embodiments, drying of the antimicrobial composition is accomplished at room temperature and left for sufficient time to evaporate all non-metal containing compounds. In some embodiment, drying of the antimicrobial composition is accelerated with additional heat, airflow, ultraviolet energy, infrared energy or microwave energy.

With the solvent fully evaporated, and the only remaining material on the substrate being one of the aforementioned antimicrobial materials thereon, such as the elemental metal. The substrate is thus able to resist the survival of microbes thereon. Furthermore, the antimicrobial material is bonded to the substrate in a way that renders it resistant to being washed off. Thus the substrate can be washed without removal of the antimicrobial material or a significant amount of the antimicrobial material.

Some examples of different combinations of metal complexes and acids are described below.

### Example 1: Silver Complex+Carbonic Acid on White Fabric Substrate

A metal salt, silver carbonate, was obtained from Sigma-Aldrich, and is combined with ethanol and a primary organo-amine to form the metal complex salt of the inorganic acid, carbonic acid: [Ag(NH3)2]-carbonate.

The resultant stock solution of [Ag(NH3)2]-carbonate had a silver metal loading of 100000 ppm, (i.e., 10% concentration by weight of metal vs. weight of total solution).

The 100000 ppm stock solution is subsequently diluted to the silver metal loading concentrations ranging from 3000 ppm down to 10 ppm, as shown in table 1 (the final usage concentration). The solutions are then applied onto a standard fabric substrate, such as white cotton textile and tested for various characteristics. Two examples of the applied solutions, at 3000 ppm and 100 ppm respectively, are shown in FIGS. 4A and 4B. The substrates, after being treated with the solution, are coated with standardized microbes, such as E. Coli or MRSA and tested for antimicrobial kill efficacy. The treated substrates are subjected to a wash test to determine if the silver metal still remains adhered to the fabric after multiple washes. For high silver metal ppm fabrics, it is easy to determine if the color of the stain fades or washes out over time. For low-ppm, non-stained items, the substrate is subjected to a digestion method to calculate the silver concentration per unit area after a number of washes to determine if the silver is remaining stable or is washing out.

TABLE 1
Test results of the antimicrobial composition of Example 1
at different silver metal loading concentrations, by weight

Substrate = white cotton fabric,
Metal selected = Silver
Microbe tested = E. Coli (OD₆₀₀ 1.5)

| | | | | | |
|---|---|---|---|---|---|
| | | Stain | Wash | Efficacy | |
| Metal | Temper- | test | test | test | |
| Loading | ature | Pass? | Pass? | Pass? | Time |

| | | | | | |
|---|---|---|---|---|---|
| 3000 | ppm | No | Yes | Not | 1 hr |
| | | | | tested | |
| 1000 | ppm | Yes | Yes | Yes | 1 hr |
| 500 | ppm | Yes | Yes | Yes | 1 hr |
| 100 | ppm | Yes | Yes | Yes | 1 hr |
| 20 | ppm | Yes | Yes | Yes | 1 hr |
| 10 | ppm | Yes | Yes | No | 1 hr |

### Example 2: Silver Complex+Formic Acid on White Fabric Substrate

The organic acid, formic acid, in the form of the metal salt, silver formate, is combined with ethanol and primary organo-amine to form: [Ag(NH3)2]-formate.

The resulting core complex is: [Ag(NH3)2]-formate at 100000 ppm concentration in alcohol solvent (i.e. the stock solution) is diluted to the silver loading contents shown in Table 2, below.

TABLE 2
Test results of the antimicrobial composition of Example 2
at different silver metal loading concentrations, by weight

Substrate = white cotton fabric,
Metal selected = Silver
Microbe tested = E. Coli (OD₆₀₀ 1.5)

| | | | Stain | Wash | Efficacy | |
|---|---|---|---|---|---|---|
| Metal | | Temper- | test | test | test | |
| Loading | | ature | Pass | Pass | Pass | Time |
| 3000 | ppm | 20 C. | No | Yes | Not | 1 hr |
| | | | | | tested | |
| 1000 | ppm | 20 C. | Yes | Yes | Yes | 1 hr |
| 500 | ppm | 20 C. | Yes | Yes | Yes | 1 hr |
| 100 | ppm | 20 C. | Yes | Yes | Yes | 1 hr |
| 20 | ppm | 20 C. | Yes | Yes | Yes | 1 hr |
| 10 | ppm | 20 C. | Yes | Yes | No | 1 hr |

### Example 3: Silver Complex+Oxalic Acid on White Fabric Substrate

The metal salt, silver oxalate, is combined with ethanol and a primary organo-amine to form the organo-metallic complex salt: [Ag(NH3)2]-oxalate.

The resulting core complex is: [Ag(NH3)2]-oxalate at 100000 ppm concentration in alcohol solvent is diluted to the silver loading contents shown in Table 3.

TABLE 3
Test results of the antimicrobial composition of Example 3
at different silver metal loading concentrations, by weight

| | | Substrate = white cotton fabric, | | | | |
|---|---|---|---|---|---|---|
| | | Metal selected = Silver | | | | |
| | | Microbe tested = E. Coli (OD₆₀₀ 1.5) | | | | |
| | | | Stain | Wash | Efficacy | |
| Metal | | Temper- | test | test | test | Thermal |
| Loading | | ature | Pass | Pass | Pass | condition |
| 3000 | ppm | 20 C. | No | Yes | Not | 1 hr |
| | | | | | tested | |
| 1000 | ppm | 20 C. | No | Yes | Yes | 1 hr |
| 500 | ppm | 20 C. | Yes | Yes | Yes | 1 hr |
| 100 | ppm | 20 C. | Yes | Yes | Yes | 1 hr |
| 20 | ppm | 20 C. | Yes | Yes | Yes | 1 hr |
| 10 | ppm | 20 C. | Yes | Yes | No | 1 hr |

### Example 4: Silver Complex+Hydrofluoric Acid on White Substrate

Hydrofluoric acid, in the form of the metal salt, silver fluoride, is combined with ammonium hydroxide to form the metal complex salt of the inorganic acid, hydrofluoric acid: [Ag(NH3)2]-fluoride.

The resulting core complex is: [Ag(NH3)2]-fluoride at 100000 ppm concentration in aqueous solvent is diluted to the silver loading contents shown in Table 4.

TABLE 4
Test results of the antimicrobial composition of Example 4
at different silver metal loading concentrations, by weight

| | | Silver | | | | |
|---|---|---|---|---|---|---|
| | | Substrate = white Coolmax ™ polyester fabric | | | | |
| | | Microbe tested = E. Coli (OD₆₀₀ 1.5) | | | | |
| | | | Stain | Wash | Efficacy | |
| Metal | | Temper- | test | test | test | |
| Loading | | ature | Pass | Pass | Pass | Time |
| 3000 | ppm | 20 C. | No | Yes | Not | 1 hr |
| | | | | | tested | |
| 1000 | ppm | 20 C. | No | Yes | Yes | 1 hr |
| 500 | ppm | 20 C. | Yes | Yes | Yes | 1 hr |
| 100 | ppm | 20 C. | Yes | Yes | Yes | 1 hr |
| 20 | ppm | 20 C. | Yes | Yes | Yes | 1 hr |
| 10 | ppm | 20 C. | Yes | Yes | No | 1 hr |

### Example 5: Silver Complex+Formic Acid; on Dark Substrate

The metal salt, silver formate, is combined with ethanol and a primary organo-amine to form the organo-metallic complex salt: [Ag(NH3)2]-formate.

The resulting core complex is: [Ag(NH3)2]-formate at 100000 ppm concentration in alcohol solvent is diluted with water to the silver loading contents shown in table 5.

In this case, the dark color of the substrate has a brown hue allowing fora broader range of silver concentration to pass the Delta E staining criteria.

TABLE 5
Test results of the antimicrobial composition of Example 5
at different silver metal loading concentrations, by weight

| | | Substrate = dark Coolmax ™ polyester fabric, | | | | |
|---|---|---|---|---|---|---|
| | | Metal selected = Silver | | | | |
| | | Microbe tested = E. Coli (OD₆₀₀ 1.5) | | | | |
| | | | Stain | Wash | Efficacy | |
| Metal | | Temper- | test | test | test | Thermal |
| Loading | | ature | Pass | Pass | Pass | condition |
| 3000 | ppm | 20 C. | Yes | Yes | Not | 1 hr |
| | | | | | tested | |
| 1000 | ppm | 20 C. | Yes | Yes | Yes | 1 hr |
| 500 | ppm | 20 C. | Yes | Yes | Yes | 1 hr |
| 100 | ppm | 20 C. | Yes | Yes | Yes | 1 hr |
| 20 | ppm | 20 C. | Yes | Yes | Yes | 1 hr |
| 10 | ppm | 20 C. | Yes | Yes | No | 1 hr |

### Example 6: Silver Complex+Formic Acid; on Skin

The metal salt, silver formate, is combined with ethanol and a primary organo-amine to form the metal complex salt of the carboxylic organic acid, formic acid: [Ag(NH3)2]-formate.

The resulting core complex is: [Ag(NH3)2]-formate at 100000 ppm concentration in alcohol solvent is diluted with water to the silver loading contents shown in Table 6.

In the case of the skin, the background color of the substrate has a reddish-pink hue allowing for a broader range of silver concentration to pass the Delta E staining criteria.

TABLE 6
Test results of the antimicrobial composition of Example 6
at different silver metal loading concentrations, by weight

| | | Substrate = Dark Coolmax ™ polyester fabric, | | | | |
|---|---|---|---|---|---|---|
| | | Metal selected = Silver | | | | |
| | | Microbe tested = E. Coli (OD₆₀₀ 1.5) | | | | |
| | | | | Hand | | |
| | | | Stain | Wash | Efficacy | |
| Metal | | Temper- | test | test | test | Thermal |
| Loading | | ature | Pass | Pass | Pass | condition |
| 3000 | ppm | 20 C. | Yes | Yes | Not | 1 hr |
| | | | | | tested | |
| 1000 | ppm | 20 C. | Yes | Yes | Yes | 1 hr |
| 500 | ppm | 20 C. | Yes | Yes | Yes | 1 hr |
| 100 | ppm | 20 C. | Yes | Yes | Yes | 1 hr |
| 20 | ppm | 20 C. | Yes | Yes | Yes | 1 hr |
| 10 | ppm | 20 C. | Yes | Yes | No | 1 hr |

### Example 7: Copper with Acetic Acid

The metal salt, copper Acetate is combined with ethyl alcohol and primary organo-amine. The resulting antimicrobial compound is a complex of the form [Cu(NH3)-acetate].

The metal salt, copper acetate, is combined with ethanol and a primary organo-amine to form the metal complex salt of the carboxylic organic acid, acetic acid: [Cu(NH3)₄(H2O)n]SO4 in organic solvent.

The resulting core complex is: [Cu(NH3)x]-acetate at 100000 ppm concentration in alcohol solvent is diluted with water to the copper loading contents shown in Table 7.

TABLE 7
Test results of the antimicrobial composition of example 2
at different silver metal loading concentrations, by weight

| | | Substrate = white cotton duvet, | | | | |
|---|---|---|---|---|---|---|
| | | Metal selected = Copper | | | | |
| | | Microbe tested = MRSA (Staphylococcus) − | | | | |
| | | | Stain | Wash | Efficacy | |
| Metal | | Temper- | test | test | test | Thermal |
| Loading | | ature | Pass | Pass | Pass | condition |
| 3000 | ppm | 60 C.-100 C. | No | No | Not | 1 hr |
| | | | | | tested | |
| 1000 | ppm | 60 C.-100 C. | No | Yes | Yes | 1 hr |
| 500 | ppm | 60 C.-100 C. | Yes | Yes | Yes | 1 hr |
| 100 | ppm | 60 C.-100 C. | Yes | Yes | Yes | 1 hr |
| 20 | ppm | 60 C.-100 C. | Yes | Yes | Yes | 1 hr |
| 10 | ppm | 60 C.-100 C. | Yes | Yes | Yes | 1 hr |

### Example 8: Copper with Sulphuric Acid

Sulphuric acid, in the form of the metal salt, copper sulfate, is combined with water and an ammonia complexing agent to form the metal complex salt of the inorganic acid, sulfuric acid: [Cu(NH3)4(H2O)n]SO4.

The resulting core complex is: [Cu(NH3)₄(H2O)n]-sulphate at 100000 ppm concentration in water solvent is diluted to the copper metal loading content, as shown in Table 8, below is tested for MRSA.

TABLE 8
Test results of the antimicrobial composition of example 4
at different copper metal loading concentrations, by weight

| | | Substrate = white cotton duvet, | | | | |
|---|---|---|---|---|---|---|
| | | Metal selected = Copper | | | | |
| | | Microbe tested = MRSA (Staphylococcus) − | | | | |
| | | | Stain | Wash | Efficacy | |
| Metal | | Temper- | test | test | test | Thermal |
| Loading | | ature | Pass | Pass | Pass | condition |
| 3000 | ppm | 60 C.-100 C. | No | No | Not | 1 hr |
| | | | | | tested | |
| 1000 | ppm | 60 C.-100 C. | No | Yes | Yes | 1 hr |
| 500 | ppm | 60 C.-100 C. | Yes | Yes | Yes | 1 hr |
| 100 | ppm | 60 C.-100 C. | Yes | Yes | Yes | 1 hr |
| 20 | ppm | 60 C.-100 C. | Yes | Yes | Yes | 1 hr |
| 10 | ppm | 60 C.-100 C. | Yes | Yes | Yes | 1 hr |

### Example 9: Zinc+Sulphuric Acid

The metal salt, zinc sulfate, is combined with water and an ammonia based complexing agent to form the antimicrobial complex salt of the inorganic acid, sulfuric acid: [Zn(NH3)4(H2O)n]O4.

The resulting core complex is: [Cu(NH3)4(H2O)n]-sulphate at 100000 ppm concentration in water solvent is diluted to the copper metal loading content, as shown in Table 9, below.

TABLE 9
Test results of the antimicrobial composition of example 8
at different zinc metal loading concentrations, by weight

| | | Substrate = white cotton duvet, | | | | |
|---|---|---|---|---|---|---|
| | | Metal selected = Copper | | | | |
| | | Microbe tested = MRSA (Staphylococcus) − | | | | |
| | | | Stain | Wash | Efficacy | |
| Metal | | Temper- | test | test | test | Thermal |
| Loading | | ature | Pass | Pass | Pass | condition |
| 3000 | ppm | 60 C.-100 C. | Yes | No | Not | 1 hr |
| | | | | | tested | |
| 1000 | ppm | 60 C.-100 C. | Yes | Yes | Yes | 1 hr |
| 500 | ppm | 60 C.-100 C. | Yes | Yes | Yes | 1 hr |
| 100 | ppm | 60 C.-100 C. | Yes | Yes | Yes | 1 hr |
| 20 | ppm | 60 C.-100 C. | Yes | Yes | Yes | 1 hr |
| 10 | ppm | 60 C.-100 C. | Yes | Yes | No | 1 hr |

One of the criteria that may be used when selecting which metal to use for the antimicrobial composition, is the colour of the substrate. For example, for white substrates, while Silver may be used, as shown above, Zinc may be used since Zinc tends to stain white. By contrast, Silver and Copper both stain brown and could be used for substrates that are darker-coloured. However, for greater certainty, it will be noted that Silver or Copper may be used in certain applications with lighter coloured substrates if their concentrations are kept below suitable threshold values, while still ensuring that they are in sufficient concentrations to be effective at killing microbes.

It is contemplated that it is novel and inventive to select the metal for use in the antimicrobial composition, based on at least one property of the substrate, such as, for example: the colour of the substrate, and the material of the substrate.

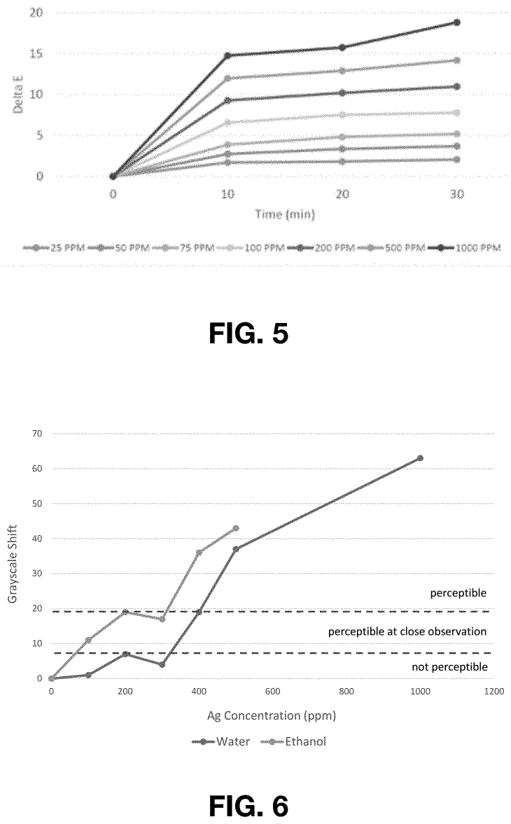

FIG. 5 shows a graph of the Delta E value for a selected substrate 300 treated with an antimicrobial composition containing Silver, at progressively higher concentrations, over time after drying at 120 degrees Celsius. Such a graph can be used to assist in selecting a metal based on the properties (e.g. the colour and/or material) of the substrate 300.

FIG. 6 is a graph showing concentration values for Silver in the antimicrobial composition, and their impact on greyscale shift, which is another measure of colour change that can be used instead of Delta E, with two different solvents.

In some examples, it has been found that a minimum of 20 ppm of metal (Silver) loading, by weight is usable in order to provide the microbe kill efficiency that would be acceptable. For some materials, such as very light materials or white materials, it has been found that a metal loading of less than 400 ppm results in virtually no staining, as can be seen in the graph shown in FIG. 6.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

1. An antimicrobial compound having the formula [Meₓ(NH3)_{y}]—Z, where Me is a metal selected from the group consisting of copper, silver and zinc, and Z is selected from the group consisting of, a salt of an organic acid having at least one (—COOH) functional group, or a salt of an inorganic acid.

2. The antimicrobial compound of claim 1, wherein Z is a salt of an inorganic acid selected from the group consisting of: Sulfurous Acid, Sulfuric Acid, Hyposulfurous Acid, Persulfuric Acid, Pyrosulfuric Acid, Disulfurous Acid, Dithionous Acid, Tetrathionic Acid, Thiosulfurous Acid, Hydrosulfuric Acid, Peroxydisulfuric Acid, Perchloric Acid, Hydrochloric Acid, Hypochlorous Acid, Chlorous Acid, Chloric Acid, Hyponitrous Acid, Nitrous Acid, Nitric Acid, Pernitric Acid, Carbonous Acid, Carbonic Acid, Hypocarbonous Acid, Percarbonic Acid, Phosphoric Acid, Phosphorous Acid, Hypophosphous Acid, Perphosphoric Acid, Hypophosphoric Acid, Pyrophosphoric Acid, Hydrophosphoric Acid, Hydrobromic Acid, Bromous Acid, Bromic Acid, Hypobromous Acid, Hypoiodous Acid, lodous Acid, Iodic Acid, Periodic Acid, Hydroiodic Acid, Fluorous Acid, Fluoric Acid, Hypofluorous Acid, Perfluoric Acid, Hydrofluoric Acid, Chromic Acid, Chromous Acid, Hypochromous Acid, Perchromic Acid, Hydroselenic Acid, Selenic Acid, Selenous Acid, Hydronitric Acid, Boric Acid, Molybdic Acid, Perxenic Acid, Silicofluoric Acid, Telluric Acid, Tellurous Acid, Tungstic Acid, Xenic Acid, Pyroantimonic Acid, Permanganic Acid, Manganic Acid, Antimonic Acid, Antimonous Acid, Silicic Acid, Titanic Acid, Arsenic Acid, Pertechnetic Acid, Hydroarsenic Acid, Dichromic Acid, Tetraboric Acid, Metastannic Acid, Hypooxalous Acid, Ferricyanic Acid, Cyanic Acid, Silicous Acid, Hydrocyanic Acid, Thiocyanic Acid, Uranic Acid, and Diuranic Acid.

3. An antimicrobial composition, comprising:
the antimicrobial compound of claim 1, in an aqueous or organic solvent selected from the group consisting of: n-Pentane, n-Hexane, n-Heptane, n-Octane, n-Nonane, n-Decane, 2,2,4-Trimethylpentane, Cyclohexane, Benzene, Toluene, Ethylbenzene, Xylene, Tetralin, Methanol, Ethanol, n-Propanol, i-Propanol, n-Butanol, i-Butanol, s-Butanol, n-Amyl alcohol, i-Amyl alcohol, Cyclohexanol, n-Octanol, Ethanediol, Diethylene 1,2-Propanediol glycol, Propylene glycol methyl ether, Ethylene glycol methyl ether, Ethylene glycol ethyl ether, Ethylene glycol monobutyl ether, Methylene chloride, Chloroform, Carbon tetrachloride, 1,2-Dichloroethane, Trichloroethylene, Perchloroethylene, Monochlorobenzene, Acetone, Methyl ethyl ketone, Methyl isobutyl ketone, Cyclohexanone, n-Methyl-2-pyrrolidone, Acetophenone, Diethyl ether, Diisopropyl ether, Dibutyl ether, Methyl tert butyl ether, 1,4-Dioxane, Tetrahydrofuran, Methyl acetate, Ethyl acetate, Isopropyl acetate, n-Butyl acetate, Cellosolve acetate, Dimethylformamide, Dimethylacetamide, Dimethylsulphoxide, Sulfolane, Carbon disulphide, Acetic acid, Aniline, Nitrobenzene, Morpholine, Pyridine, 2-Nitropropane, Acetonitrile, Furfuraldehyde, Phenol and water.

4. An antimicrobial composition as claimed in claim 3, wherein the solvent further includes a pH adjustment compound that is different than the antimicrobial compound, and which contains an N—H chemical group, such that the pH of the antimicrobial composition is greater than about 8.

5. An antimicrobial composition as claimed in claim 3, wherein the maximum metal content in the antimicrobial composition is greater than 10 ppm and less than 10000 ppm of metal, by weight.

6. An antimicrobial composition as claimed in claim 3, wherein the maximum metal content in the antimicrobial composition is greater than 50 ppm and less than 5000 ppm of metal, by weight.

7. An antimicrobial composition as claimed in claim 3, wherein the maximum metal content in the antimicrobial composition is greater than 90 ppm and less than 1000 ppm of metal, by weight.

8. A topical antimicrobial composition for human or animal skin, comprising the antimicrobial compound of claim 1.

9-18. (canceled)
